(19) United States
(12) Patent Application Publication
(10) Pub. No.: US 2006/0051259 A1
(43) Pub. Date: Mar. 9, 2006

(54) Ozone generator

(76) Inventor: Shih-Lan Chiu, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/180,665

(22) Filed: Jul. 14, 2005

(30) Foreign Application Priority Data
Sep. 7, 2004 (TW) 93214238

(51) Int. Cl. B01J 19/08

(52) U.S. Cl. 422/186.07; 422/186.18

(57) ABSTRACT

An ozone generator has an insulating structure, two metallic boards and at least one metallic wire. The two metallic boards form a passage therebetween and electrically connect to an anode of high-voltage pulse direct current. The at least one metallic wire is disposed in the passage and electrically connects to a cathode of the high-voltage pulse direct current. In the preferred embodiment the at least one metallic wire has a quantity of more than two. The metallic wires are arranged along the flow direction of the passage in sequence. The high-voltage pulse direct current directly forces the at least one metallic wire to perform point discharge, so that oxygen passing through the passage is ionized continuously to produce ozone.

### BACKGROUND OF THE INVENTION

1. Field of the Invention

The present invention relates to an ozone generator, and more particularly, to an ozone generator that uses high-voltage pulse direct current to produce ozone.

2. Description of Related Art

The great progress of industrial development makes human's lives better, but also results a great negative effect to our natural environment. For example, air pollution and water pollution, latent in the environment, cause harm to human beings. To provide safer and more comfortable environment and also improve human's quality of life, manufacturers develop many types of cleaning and disinfecting devices, such as an ozone generator. Ozone has a variety of beneficial effects such as disinfecting, freshening, detoxifying, and deodorizing. It can also be used in a number of medical treatments, beauty and bleaching treatments, and improving air quality. As ozone can be easily reformed as oxygen, ozone generators can be applied broadly to our living and working environments. For example, ozone generators are often applied to a wide variety of objects, such as small tableware drying apparatus or large water treatment plants.

A conventional ozone generator substantially includes quartz or glass with a metallic net, and direct or alternating current is supplied to the ozone generator for ionizing oxygen to produce ozone.

The conventional ozone generator only produces low concentration ozone, and the efficiency thereof is inadequate for equipments that require high standard of completely clean or disinfected. In addition, the conventional ozone generator has a large number of components, and it is large in size and costly to produce.

Accordingly, as above description, the conventional ozone generator still has some drawbacks that could be improved. The present invention aims to resolve the drawbacks in the prior art.

### SUMMARY OF THE INVENTION

The primary object of the invention is therefore to specify an ozone generator that produces ozone more efficiently.

Another object of the invention is to specify an ozone generator, which has fewer materials and parts than conventional types of ozone generators, and thereby the size and cost of the device are both reduced.

According to the invention, the above objects are achieved via an ozone generator comprising an insulating structure, two metallic boards and at least one metallic wire. The two metallic boards are fixed in the insulating structure. The two metallic boards form a passage therebetween. The passage forms an inlet and an outlet respectively at two ends thereof and a flow direction being defined from the inlet to the outlet. The two metallic boards electrically connect to an anode of high-voltage pulse direct current. The at least one metallic wire is disposed in the passage and has two ends fixed to the insulating structure. The at least one metallic wire and the flow direction are arranged in a crossed manner. The at least one metallic wire electrically connects to a cathode of the high-voltage pulse direct current.

The at least one metallic wire is disposed in the passage, and the two metallic boards and the at least one metallic wire are respectively electrically connected to an anode and a cathode of high-voltage pulse direct current, so that the high-voltage pulse direct current directly forces the at least one metallic wire to perform point discharge, so that the efficiency of producing ozone from oxygen passing through the passage is increased. As such the materials and parts of the ozone generator are fewer in number thereby reducing the size and cost of the device.

In the preferred embodiment, the two metallic boards are disposed parallel to each other, and the at least one metallic wire is arranged parallel to the two metallic boards and perpendicular to the flow direction of the passage, so that oxygen passing through the passage is ionized evenly.

In the preferred embodiment, the at least one metallic wire has a quantity of more than two, the metallic wires are arranged along the flow direction of the passage in sequence, and the metallic wires are electrically connected to each other to continuously discharge electricity, so that oxygen passing through the passage is ionized continuously to produce ozone. Thereby, ozone is produced more efficiently and in a greater amount than the prior art.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic perspective view of an ozone generator of the present invention;

FIG. 2 is a front view of an ozone generator of the present invention;

FIG. 3 is a side view of an ozone generator of the present invention;

FIG. 4 is a cross-sectional view taking along line 4-4 of FIG. 3; and

FIG. 5 is a schematic perspective view of another embodiment of an ozone generator of the present invention.

### DETAILED DESCRIPTION OF THE PREFERRED EMBODIMENTS

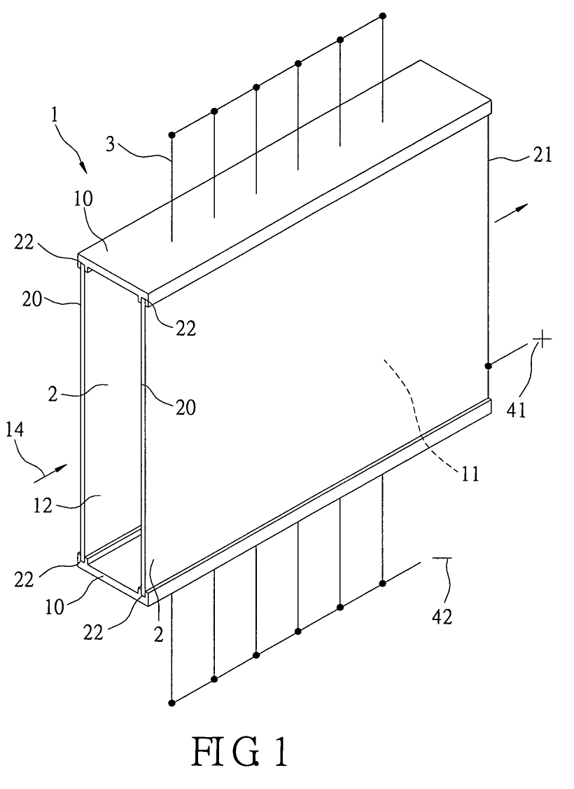

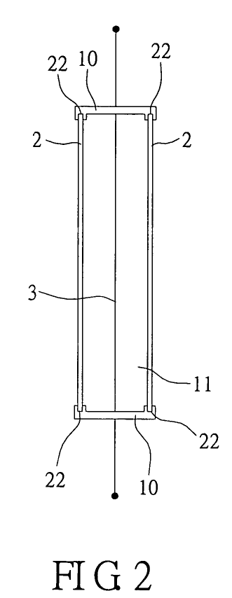

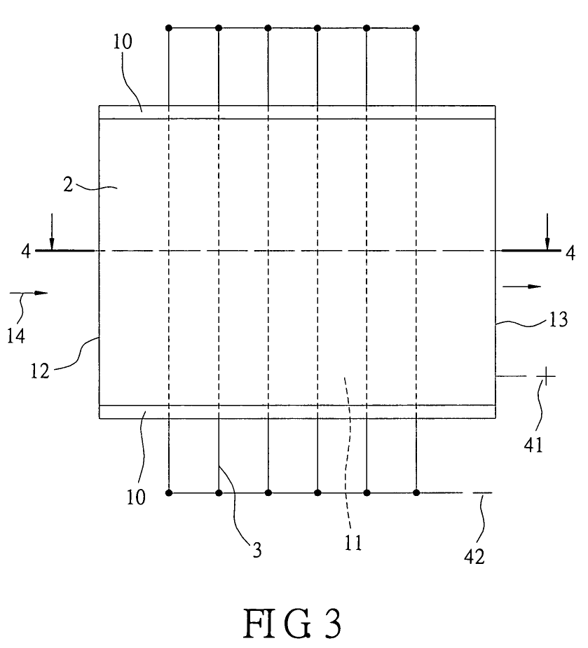

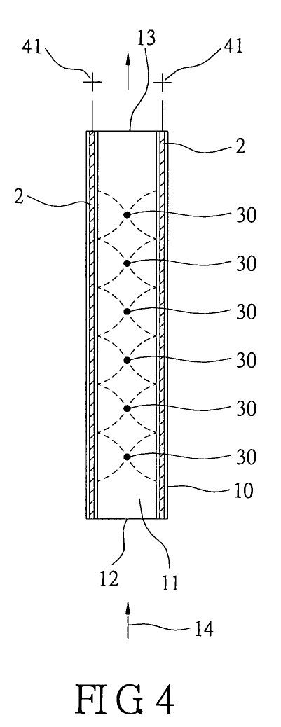

Referring to FIGS. 1-4, the present invention provides an ozone generator. The ozone generator comprises an insulating structure 1, two metallic boards 2, and at least one metallic wire 3.

The insulating structure 1 may have different designs according to the equipment into which the ozone generator of the present invention is installed. In this embodiment, the insulating structure 1 includes two insulating boards 10.

The two metallic boards 2 are fixed in the insulating structure 1. In this embodiment, each of the two metallic boards 2 has a front edge 20, a rear edge 21 and two fixing edges 22. Each of the two insulating boards 10 connects with the two metallic boards 2 through corresponding fixing edges 22 by using a sticking, screwing or tightening manner, so that the two metallic boards 2 are disposed parallel to each other. The two metallic boards 2 form a passage 11 therebetween. The passage 11 forms an inlet 12 and an outlet 13 respectively at two ends thereof. The inlet 12 and the outlet 13 are respectively located on the front edges 20 and the rear edges 21 of the two metallic boards 2. A flow direction 14 is defined from the inlet 12 to the outlet 13, and the two metallic boards 2 electrically connect to an anode of high-voltage pulse direct current 41.

The at least one metallic wire 3 is disposed in the passage 11 and has two ends fixed to the insulating structure 1. The at least one metallic wire 3 is arranged parallel to the two metallic boards 2 and perpendicular to the flow direction 14 of the passage 11, so that the at least one metallic wire 3 and the flow direction 14 are arranged in a crossed manner. In addition, the at least one metallic wire 3 electrically connects to a cathode of the high-voltage pulse direct current 42. The distance between the at least one metallic wire 3 and the two metallic boards 2 may depend on the voltage value of the high-voltage pulse direct current.

When oxygen (O₂) enters the passage 11 from the inlet 12, it flows along the flow direction 14. The high-voltage pulse direct current directly forces the at least one metallic wire 3 to perform point discharge, so that the at least one metallic wire 3 forms several separate discharging points 30 thereon to discharge electricity to the two metallic board 2, so that oxygen is ionized and becomes ozone (O₃). In addition, the at least one metallic wire 3 is arranged parallel to the two metallic boards 2 and is perpendicular to the flow direction 14 of the passage 11, so that oxygen passing through the passage 11 is ionized evenly. In this embodiment, the at least one metallic wire 3 has a quantity of more than two. The metallic wires 3 are arranged along the flow direction 14 of the passage 11 in sequence, and the metallic wires 3 are electrically connected to each other to continuously discharge electricity. Oxygen (O₂) particles that are not ionized by the first one of the metallic wires 3 continuously flow along the flow direction 14 and may be ionized by the second one of the metallic wires 3 to produce ozone (O₃). Any oxygen particles that are not ionized by the second one of the metallic wires 3 may be ionized by the third one of the metallic wires 3 to produce ozone. In this manner, oxygen is continuously ionized to produce ozone that is emitted through the outlet 13.

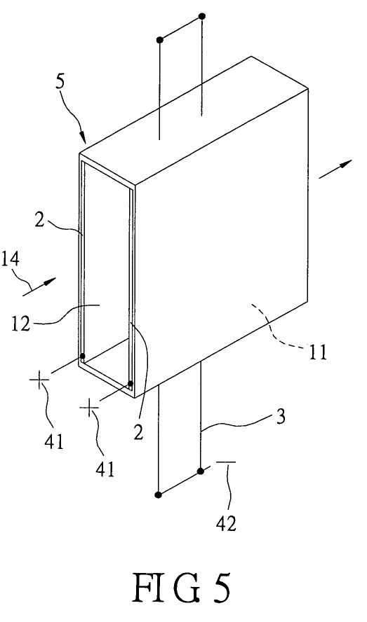

FIG. 5 shows another embodiment of the ozone generator of the present invention. In comparison with the above embodiment, the insulating structure 5 of the embodiment in FIG. 5 has an integral casing. The two metallic boards 2 are fixed in the insulating structure 5 by using a sticking, screwing or insert-molding manner. Therefore, the types of the insulting structure 5 may be changed. In addition, the quantity of the at least one metallic wires 3 may be increased or decreased.

As indicated above, the ozone generator of the present invention has the following advantages:

(1) The at least one metallic wire is disposed in the passage, and the two metallic boards and the at least one metallic wire are respectively electrically connected to an anode and a cathode of high-voltage pulse direct current, so that the high-voltage pulse direct current directly forces the at least one metallic wire to perform point discharge, so that ozone is produced more efficiently, and the materials and parts of the ozone generator are fewer in number thereby reducing the size and cost of the device.

(2) The two metallic boards are disposed parallel to each other, and the at least one metallic wire is arranged parallel to the two metallic boards and perpendicular to the flow direction of the passage, so that oxygen passing through the passage is ionized evenly.

(3) The at least one metallic wire has a quantity of more than two, the metallic wires are arranged along the flow direction of the passage in sequence, and the metallic wires are electrically connected to each other to continuously discharge electricity, so that oxygen passing through the passage is ionized continuously to produce ozone. Thereby, ozone is produced more efficiently and in a greater amount than the prior art.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An ozone generator comprising:
an insulating structure;
two metallic boards fixed in the insulating structure, the two metallic boards forming a passage therebetween, the passage forming an inlet and an outlet respectively at two ends thereof and a flow direction being defined from the inlet to the outlet, and the two metallic boards electrically connecting to an anode of high-voltage pulse direct current; and
at least one metallic wire disposed in the passage and having two ends fixed to the insulating structure, the at least one metallic wire and the flow direction being arranged in a crossed manner, and the at least one metallic wire electrically connecting to a cathode of the high-voltage pulse direct current.

2. The ozone generator as claimed in claim 1, wherein the two metallic boards are disposed parallel to each other, and the at least one metallic wire is arranged parallel to the two metallic boards and perpendicular to the flow direction of the passage.

3. The ozone generator as claimed in claim 2, wherein the at least one metallic wire has a quantity of more than two, the metallic wires are arranged along the flow direction of the passage in sequence, and the metallic wires are electrically connected to each other.

4. The ozone generator as claimed in claim 1, wherein the insulating structure includes two insulating boards, each of the two metallic boards has a front edge, a rear edge and two fixing edges, each of the two insulating boards connects with the two metallic boards through corresponding fixing edges, and the inlet and the outlet are respectively located on the front edges and the rear edges of the two metallic boards.
